(19) United States
(12) Patent Application Publication
(10) Pub. No.: US 2018/0317262 A1
(43) Pub. Date: Nov. 1, 2018

(54) CONDITIONAL RANDOM ACCESS

(71) Applicant: Intel IP Corporation, Santa Clara, CA (US)

(72) Inventors: Rongzhen YANG, Shanghai (CN); Peng MENG, Shanghai (CN); Qinghua LI, San Ramon, CA (US); Robert J. STACEY, Portland, OR (US); Po-Kai HUANG, San Jose, CA (US)

(21) Appl. No.: 15/756,525

(22) PCT Filed: Sep. 29, 2015
(86) PCT No.: PCT/US2015/052914

§ 371 Date: Feb. 28, 2018

(51) Int. Cl. H04W 74/08; H04B 17/318

(52) U.S. Cl. CPC H04W 74/0833; H04B 17/318

(57) ABSTRACT

This disclosure describes methods, apparatus, and systems related to a conditional random access system. A device may identify a random access trigger frame on a communication channel, received from a first device, the trigger frame includes at least in part one or more random access resource units and one or more random access conditions. The device may measure a power level of the random access trigger frame. The device may determine a transmit power level associated with the device. The device may determine a received signal power level associated with the first device based at least in part on the one or more random access conditions.

### TECHNICAL FIELD

This disclosure generally relates to systems and methods for wireless communications and, more particularly, to a conditional random access between wireless devices.

### BACKGROUND

Wireless devices are becoming widely prevalent and are increasingly requesting access to wireless channels. A next generation WLAN, IEEE 802.11ax or High-Efficiency WLAN (HEW), is under development. HEW utilizes Orthogonal Frequency-Division Multiple Access (OFDMA) in channel allocation.

### BRIEF DESCRIPTION OF THE DRAWINGS

FIG. 1 depicts a network diagram illustrating an example network environment of an illustrative a conditional random access system, in accordance with one or more example embodiments of the present disclosure.

FIG. 2 depicts an illustrative schematic diagram of a conditional random access scheme, in accordance with one or more example embodiments of the present disclosure.

FIG. 3 depicts an illustrative flow diagram of a conditional random access algorithm execution on a user device, in accordance with one or more example embodiments of the present disclosure.

FIG. 4 depicts a flow diagram of an illustrative process for a conditional random access system, in accordance with one or more embodiments of the disclosure.

FIG. 5 depicts a flow diagram of an illustrative process for a conditional random access system, in accordance with one or more embodiments of the disclosure.

FIG. 6 illustrates a functional diagram of an example communication station that may be suitable for use as a user device, in accordance with one or more example embodiments of the disclosure.

FIG. 7 is a block diagram of an example machine upon which any of one or more techniques (e.g., methods) may be performed, in accordance with one or more embodiments of the disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

A design target for IEEE 802.11ax or High-Efficiency WLAN (HEW) is to include methods to improve the efficiency of Wi-Fi, and specifically the efficiency in dense deployments of Wi-Fi devices, such as in malls, conference halls, etc. HEW, in furtherance of such design targets, may use OFDMA techniques for channel access in the uplink and downlink directions. It is understood that the uplink direction is from a user device to an access point (AP), and the downlink direction is from an AP to one or more user devices. In the uplink direction, one or more user devices may be communicating with the AP and may be competing for channel access in a random channel access mechanism. In such cases, the channel access in OFDMA may require coordination among the various user devices that may be competing to access the operating channel simultaneously. A trigger frame may be utilized to coordinate the uplink OFDMA operations, and may include a preamble along with other signaling, such as resource allocation. In this sense, a trigger frame may be a frame that includes a preamble and other fields that may be sent from an AP informing all user devices serviced by the AP that channel access is available.

The distances between one or more user devices and an AP may vary based on the locations of these user devices. Because of the varying distances, the received signal power from the user devices may be different. A received signal power level may be the power level of a signal sent from a user device and received at the AP. The difference in the received signal power strength of signals sent from one or more user devices may be larger than, for example, 20 dB, resulting in performance degradation. One performance indicator of one or more user devices using random access may be packet error rate (PER). PER may be increased in conditions where there are mixed high and low received signal power.

Example embodiments of the present disclosure relate to systems, methods, and devices for conditional random access.

To remedy the degradation of power levels, one or more conditions or rules may be published by the AP using a random access trigger frame. The AP may send the random access trigger frame to user devices that are serviced by that AP. The one or more conditions or rules may be determined or identified on the AP side or on the user device side. The user devices may determine if these conditions or rules are met before attempting to access the operating channel. If the published conditions or rules are met, then the user devices are allowed to send their uplink data. That is, the uplink data may be sent from the user device to the AP in the uplink direction. In accordance with aspect of the disclosure, the user device may select a resource unit to send its uplink data. The resource units may be provided by the random access trigger frame sent from the AP to the user devices. Some embodiment of this disclosure may limit the difference between the power levels of signals received at, for example, the AP, which may improve the overall system performance.

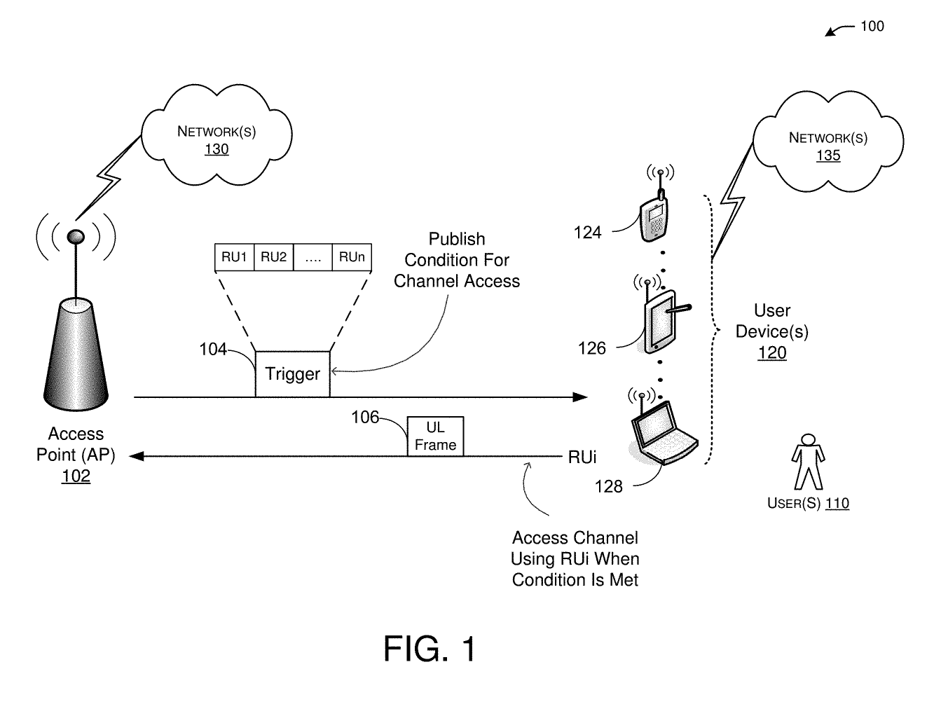

FIG. 1 is a network diagram illustrating an example network environment, according to some example embodiments of the present disclosure. Wireless network 100 can include one or more user devices 120 and one or more AP 102, which may communicate in accordance with IEEE 802.11 communication standards, including IEEE 802.11ax (HEW). The user device(s) 120 may be mobile devices that are non-stationary and do not have fixed locations.

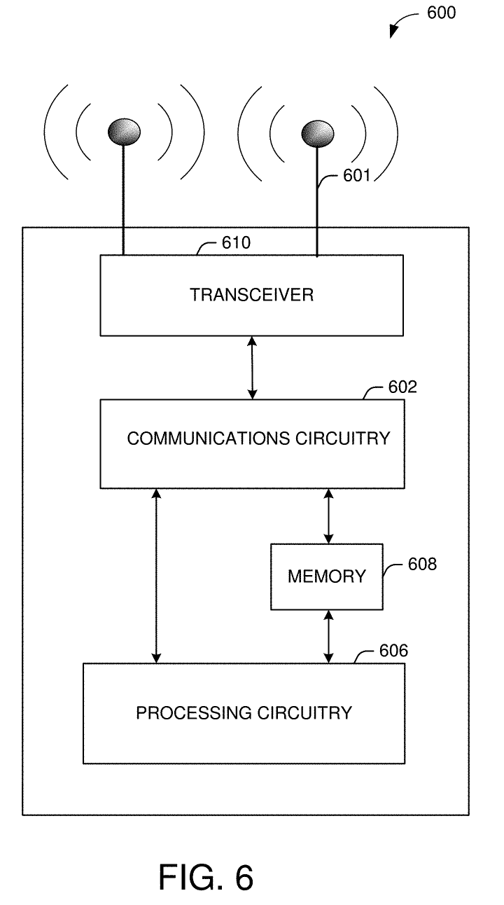

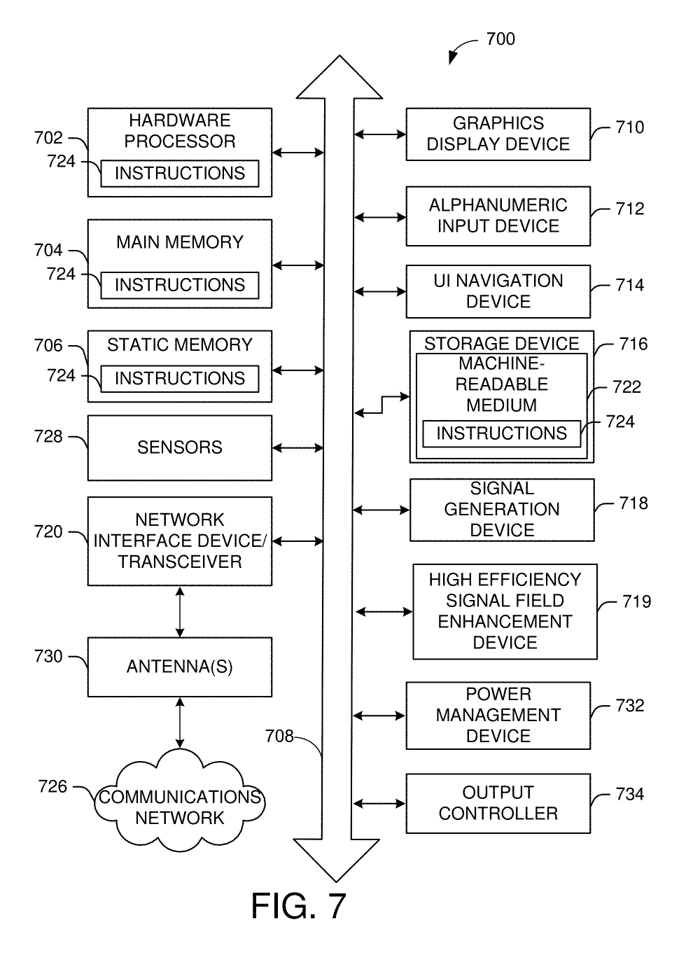

In some embodiments, the user devices 120 may include one or more computer systems similar to that of the functional diagram of FIG. 6 and/or the example machine/system of FIG. 7.

One or more illustrative user device(s) 120 may be operable by one or more user(s) 110. The user device(s) 120 (e.g., user devices 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth.

Any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 124 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In accordance with embodiments of the disclosure, the wireless network 100 provides a conditional random access system that enable access by user devices 120 to available resource units, which may avoid the inefficiencies of scheduled allocation of the available resource units by an AP. For example, the user devices 120, including HEW user devices, may select, where the selection may be random, the particular resource to utilize for transmitting their data. However, even though random selection of resources by the user devices 120 may be an efficient utilization of the available resources in certain instance, there may be other instances where it may be desirable for the user devices 120 to be scheduled or assigned access to the wireless channel.

In an illustrative case of random access, the AP 102 may send a random access trigger frame 104 indicating that resource units (RUs) are available for accessing a wireless channel established between the AP and one or more user devices. When user devices 120 receive the random access trigger frame, the user devices 120 may select the RUs to send their respective up link (UL) data 106.

The resource units may be represented by RU1, RU2, . . . , RUn, where “n” is an integer. These resource units may be arranged in a sequence such that a user device 120 may select a resource unit when the user device is ready to transmit its data. These resource units may be resources in time domain, frequency domain or a combination of time and frequency domain. When a user device 120 detects the trigger frame 104, the user device 120 may determine that the trigger frame is a random access trigger frame (or a scheduled access trigger frame). In the case of a random access trigger frame, the determination may be enabled by the AP setting an identifier in the trigger frame or by other means to flag the trigger frame as a random access trigger frame. The user device 120 may then select a resource unit from the resource units referenced in the trigger frame 104 by which to transmit at least a portion of its data (e.g., UL data 106) to the AP 102. The UL data 106 may include one or more of a resource request frame, a management frame such as probe request, an association request or access network query protocol (ANQP) frame, a quality of service (QoS) data frame, or power save poll (PS-Poll), etc.

In one embodiment, one or more user devices 120 may be able to measure a received power level, such as, a received signal strength indication (RSSI) of the received random trigger 104. The received random trigger frame 104 may contain one or more conditions or rules related to the random access of the one or more user devices. Using the measured RSSI of the random trigger frame 104 and the one or more conditions or rules contained in the random trigger frame, a user device 120 may estimate the received signal power level on receiving device side and then decide whether to perform random access or not. This may achieve uniformity between the different user devices that may be at various distances from each other and from the AP, which in turn may eliminate the large difference of received signal power on receiving side. Namely, a conditional random access system may limit the gap of received power levels in different RUs within a random access transmission opportunity period (TxOP), which may improve the overall system performance For example, user device 128 may select RUi, where “i” is an integer, to transmit its uplink data 106 after a determination that the published one or more conditions or rules by the random trigger frame 104 were met. The overall system performance may be improved because only user devices that meet these conditions are allowed to transmit to the AP. This may prevent receiving signals with big power level discrepancies at the AP. TxOP may be a bounded time interval during which a user device may send one or more frames during the duration of the TxOP.

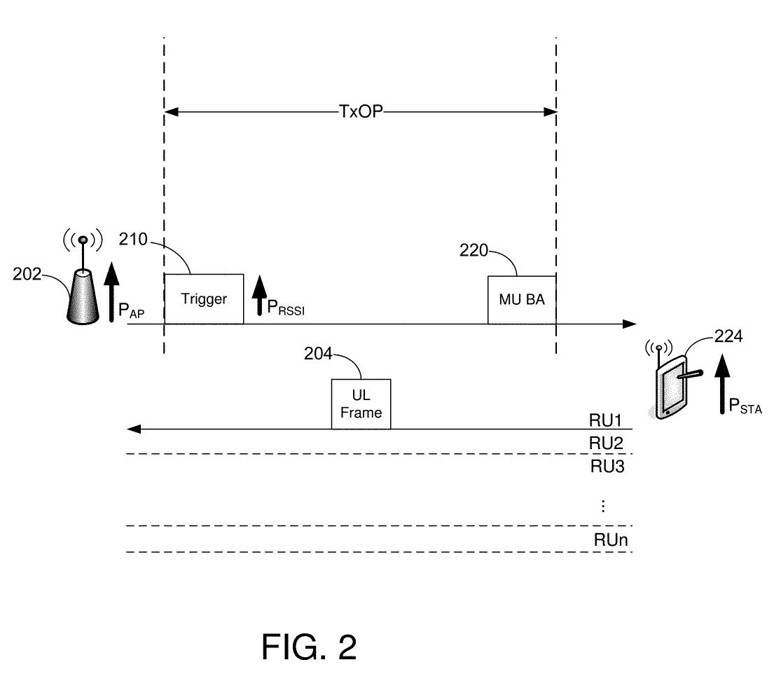

FIG. 2 depicts an illustrative schematic diagram of a conditional random access scheme, in accordance with one or more example embodiments of the present disclosure.

In one embodiment, one or more conditions or rules for providing random access to one or more user devices during a communication session between one or more devices may be implemented. For example, during a communication session between AP 202 and user device 224, the one or more conditions or rules may be implemented such that user device 224 is able to transmit its UL data (e.g., via UL frame 204) if the one or more conditions are met or ultimately satisfied. The one or more conditions or rules may be carried in a random trigger frame 210. It is understood that a trigger frame 210 may be a media access control (MAC) layer management frame or a physical layer (PHY) control frame. The one or more conditions or rules may contain one or more key information to support the one or more embodiments of the present disclosure.

In one embodiment, the one or more key information may include a transmission power level, a maximum received signal power level, and/or a minimum received signal power level. The transmission power level, denoted as P_{ap,tx}, may be the transmission power level of the trigger frame trigger 210. P_{ap,tx} may be quantized in multiple bits. For example, P_{ap,tx} may be quantized in 7 bits to express −32 dBm to 31.5 dBm with 0.5 dB step. The maximum received signal power, denoted as P_{rx,max} may be the maximum received signal power limitation for each user device (e.g., user device 224) when checking the one or more conditions or rules. P_{rx,max} may be quantized in multiple bits. For example, P_{rx,max} may be quantized as 8 bits to express 20 dBm to −107.5 dBm with 0.5 dB step. The minimum received signal power, denoted as P_{rx,min} may be the minimum received signal power limitation for each user device (e.g., user device 224) when checking the one or more conditions or rules. P_{rx,min} may be quantized in multiple bits. For example, P_{rx,min} may be quantized as 8 bits to express 20 dBm to −107.5 dBm with 0.5 dB step. It is understood that the values above are only examples and that other values for the various power levels may be employed.

In one embodiment, the user device 224 performing random access in a designated TxOP may measure the RSSI of the received random access trigger frame 210. The measurement may be expressed as a power measurement, denoted as P_{RSSI}. The user device may then estimate the instant pathloss by comparing the transmission power level (e.g., P_{ap,tx}) and P_{RSSI}. This may be achieved by the following equation:

L=P_{ap,tx}−P_{RSSI} Equation. 1

By the estimated pathloss value (expressed in dB), each user device may estimate what the power level of its transmission would be when received by the AP based on the pathloss:

Pᵣₓ=P_{sta,tx}−L Equation. 2

Where, P_{sta,tx} is the transmit power level of the user device and Pᵣₓ is the received power level of the transmission at the AP.

By estimating the received signal power on AP side, each user device may check whether it meets the following two conditions:

Pᵣₓ<=P_{rx,max} Condition. 1

And

Pᵣₓ>=P_{rx,min} Condition. 2

When both condition. 1 and condition. 2 are met, the user device may attempt to utilize an RU to access the channel during the designated TxOP using the random access. In the event either one of condition. 1 or condition. 2 was not met, the user device may not access the channel using any of the RUs at that time.

In one embodiment, a user device that may have been denied random access to the channel may periodically re-attempt by re-evaluating the above equations and conditions. The re-attempts may be based on one or more parameters. The one or more parameters may include, at least in part, predetermined time duration, a detected change in conditions, a user setting, etc. The one or more parameters may be set by an administrator, by the user device, or even the AP.

In one embodiment, some user devices with power control capability may be able to adjust their own transmission power to meet the above conditions (e.g., condition. 1 and condition. 2). For example, if a user device (e.g., user device 224) determines that the condition. 1 and/or condition. 2 were not met, the user device may perform power adjustment in order to meet these conditions. For example, the user device may perform power adjustment using the below equation:

P_{sta,tx}=P_{rx,max}+L Equation. 3

When the power adjustment has been performed, the user device may recheck the above conditions (e.g., condition. 1 and condition. 2). If the conditions are met, the user device may perform random access within the random access TxOP.

In one embodiment, after the user device 224 transmits its UL data 204, the AP 202 may send a Multi User Block Acknowledge (MU-BA) 220 to the user device 224. The MU-BA 220 may be used as a feedback mechanism from a device that may have received data to a device that may have sent the data.

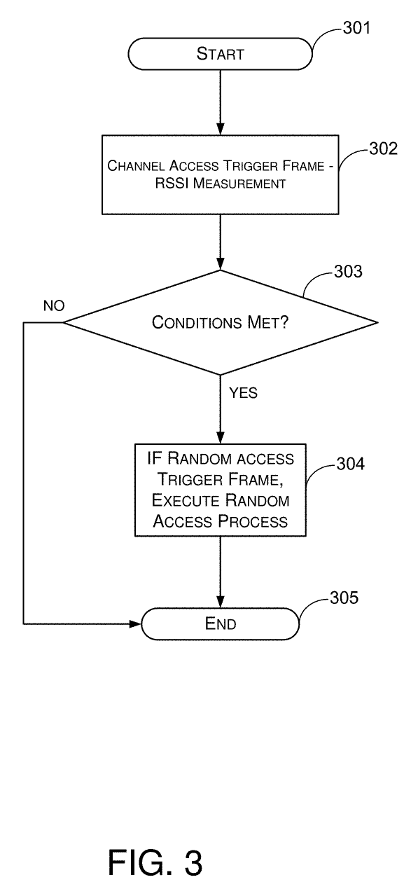

FIG. 3 depicts an illustrative flow diagram of a conditional random access algorithm execution on a user device, in accordance with one or more example embodiments of the present disclosure.

At block 301, a conditional access procedure may be started when a channel access trigger frame (e.g., a random access trigger frame) is received by a user device from an AP. In certain embodiments, the channel access trigger frame may include one or more condition(s) or rule(s) that the receiving user device is to satisfy before sending data on an uplink resource unit. For example, one such condition may be a transmission power level associated with the AP, a maximum received signal power level associated with the AP, or a minimum received signal power level associated with the AP.

At block 302, the user device may measure the RSSI of the received channel access trigger frame. At block 303, the user device may determine if the condition(s) or rule(s) included in the channel access trigger frame is satisfied, such as by first executing the equation. 1 and equation. 2 above. The user device may then check condition. 1 and condition. 2 to determine whether the rule(s) or condition(s) has been met. At block 304, the user device may execute a random access selection of resource units in accordance with a communication standard, such as the IEEE 802.11ax standard, if a random access trigger frame was received. At block 305, the procedure may be terminated after the user device selects the RU when randomly accessing the channel In the case at least of the conditions was not met, the execution may end. However, if the user device is capable of adjusting its power level, the user device may adjust the power level in order to meet condition 1 and condition 2. In that case, the user device is allowed to select the RU to transmit its data.

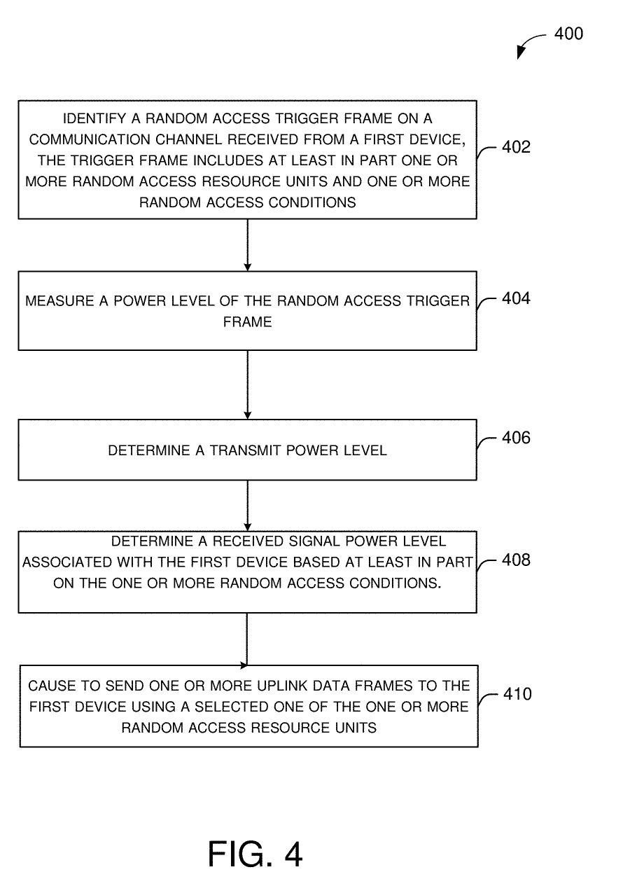

FIG. 4 illustrates a flow diagram of illustrative process 400 for conditional random access, in accordance with one or more embodiments of the disclosure.

At block 402, a user device may listen to a communication channel with an AP. The AP may send a trigger frame to one or more user devices. The trigger frame may advise the one or more user devices that RUs are available for the user devices. The trigger frame may contain RUs for random access or may contain schedule RUs for specific user devices. In the case of random access RUs, user devices may determine that the trigger frame is a random access trigger frame. In addition to the RUs, the random access trigger frame may also contain one or more random access conditions. The one or more random access conditions may comprise, at least in part, a transmission power level of the AP, a maximum received signal power level associated with the AP, or a minimum received signal power level associated with the AP. The transmission power level of the AP may indicate the power level the AP may transmit at. The maximum received signal power level is the maximum power level of received signals at the AP that the AP allows. The minimum received signal power level is the minimum power level of received signals at the AP that the AP allows.

At block 404, the user device may measure a power level of the identified random access trigger frame. For example, the user device may be able to measure a received power level, such as, a received signal strength indication (RSSI) of the received random trigger frame.

At block 406, the user device may determine a transmit power level associated with the user device to be used when transmitting data to the AP. That is, the user device may determine at which power level to transmit data. This transmit power level be based on the user device itself, for example, the size, manufacturer, battery limitations, etc.

At block 408, the user device may determine a received signal power level associated with the AP based on the one or more random access conditions. Since the user device at this point may know the power level of the received random access frame and the transmission power level of the AP (retrieved from the trigger frame), the user device may estimate a path loss power level. The user device may then estimate what the power level of the data sent by the user device when it is received at the AP.

At block 410, the user device may determine whether the received signal power level is between the minimum and the maximum received signal power levels, then the user device is allowed to select an RU to transmit its data. On the other hand, if the received signal power level did not meet the one or more random access conditions, then the user device is not allowed to select an RU at that time (e.g., TxOP period).

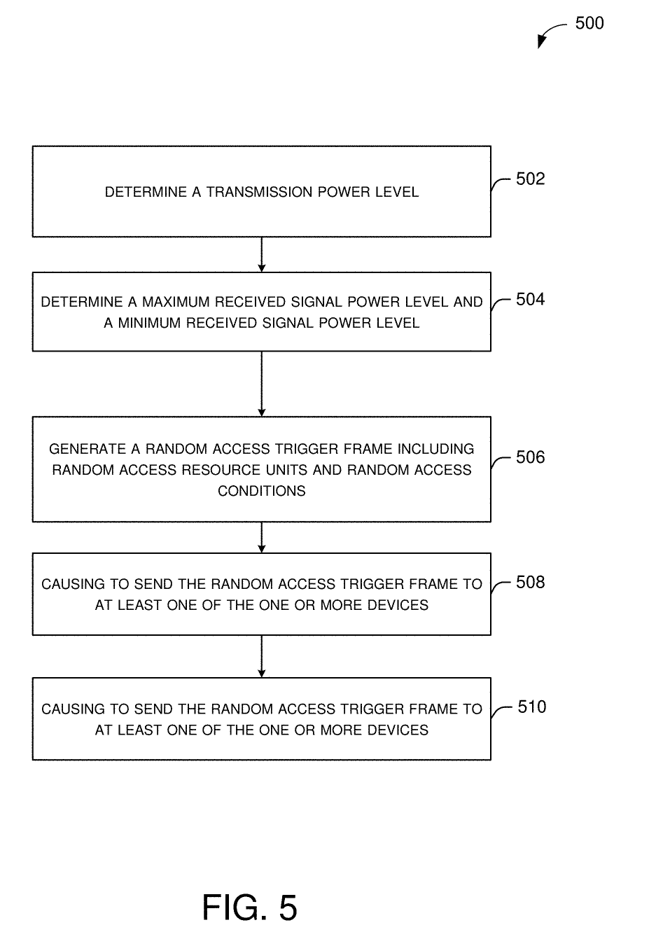

FIG. 5 illustrates a flow diagram of illustrative process 500 for conditional random access, in accordance with one or more embodiments of the disclosure.

At block 502, an AP may determine a transmission power level that the AP may transmit a random access trigger frame. The random access trigger frame may be sent on a communication channel to one or more user devices.

At block 504, the AP may determine a maximum received signal power level and a minimum received signal power level associated with at least one signal received from one or more devices. The maximum received signal power level is the maximum power level of received signals at the AP that the AP allows. The minimum received signal power level is the minimum power level of received signals at the AP that the AP allows.

At block 506, the AP may generate a random access trigger frame identifying at least in part one or more random access RUs and one or more random access conditions. These conditions may include at least one of the transmission power level, the maximum received signal power level, or the minimum received signal power level.

At block 508, the AP may send the random access trigger frame to at least one of the one or more user devices. The random access trigger frame would signal to the user devices that resource units are available for selection, such that the user devices can transmit their data to the AP.

At block 510, the AP may identify one or more data frames that may be sent from the one or more user devices using the RUs that were published in the random access trigger frame. After receiving one or more data frames data frames, the AP may send a multi-user block acknowledgment (MU-BA) the user devices to acknowledge the reception of the data frames.

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or communication station user device 120 (FIG. 1) in accordance with some embodiments. The communication station 600 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer communications and/or medium access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 2-5.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device may, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a conditional random access device 719, a network interface device/transceiver 720 coupled to antenna(s) 730, and one or more sensors 728, such as a global positioning system (GPS) sensor, compass, accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The conditional random access device 719 may be carry out or perform any of the operations and processes (e.g., processes 400 and 500) described and shown above. For example, the conditional random access device 719 may measure a received power level, such as, a received signal strength indication (RSSI) of a received random trigger frame (e.g., trigger frame 104). The received random trigger frame may contain one or more conditions or rules related to the random access of the one or more user devices. Using the measured RSSI of the random trigger frame and the one or more conditions or rules contained in the random trigger frame, a user device may estimate the received signal power level on receiving device side and then decide whether to perform random access or not. This may achieve uniformity between the different user devices that may be at various distances from each other and from the AP, which in turn may eliminate the large difference of received signal power on receiving side. Namely, a conditional random access system may limit the gap of received power levels in different RUs within a random access transmission opportunity period (TxOP), which may improve the overall system performance

While the machine-readable medium 722 is illustrated as a single medium, the term “machine-readable medium” may include a single medium or multiple media (e.g., a centralized or distributed database, and/or associated caches and servers) configured to store the one or more instructions 724.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., processes 400 and 500) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

A system of one or more computers can be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. One general aspect includes at least one memory that stores computer-executable instructions; and at least one processor of one or more processors configured to access the at least one memory, where the at least one processor is configured to execute the computer-executable instructions to: identify a random access trigger frame on a communication channel, received from a first device, the trigger frame includes at least in part one or more random access resource units and one or more random access conditions; measure a power level of the random access trigger frame; determine a transmit power level associated with the device; and determine a received signal power level associated with the first device based at least in part on the one or more random access conditions. Other embodiments of this aspect include corresponding computer systems, apparatus, and computer programs recorded on one or more computer storage devices, each configured to perform the actions of the methods.

Implementations may include one or more of the following features. The received signal power level may be a power level of a signal sent from the device and received at the first device. The one or more random access conditions may include a transmission power level associated with the first device, a maximum received signal power level associated with the first device, or a minimum received signal power level associated with the first device. The at least one processor of the one or more processors may further be configured to execute the computer-executable instructions to select one of the one or more random access resource units when the receive signal power level is greater than or equal to the minimum receive signal power level and when the receive signal power level is less than or equal to the maximum receive signal power level. The at least one processor of the one or more processors may be further configured to execute the computer-executable instructions to determine a path loss power level based at least in part on the transmission power level associated with the first device and the measured power level of the random access trigger frame. The computer-executable instructions to determine a receive signal power level associated with the first device may further include computer-executable instructions to subtract the path loss power level from the transmit power level. The device where the power level of the random access trigger frame is a received signal strength indication (RSSI) measurement. The device further including: a transceiver configured to transmit and receive wireless signals; an antenna coupled to the transceiver. The device may also include one or more processors in communication with the transceiver. The at least one data frame may be received on one of the one or more random access resource units. The one or more resource units may be orthogonal frequency division multiple access (OFDMA) resource units. The computer-executable instructions may cause the processor to further perform operations including causing to send a multi user block acknowledgment to at least one of the one or more devices based at least in part on the received at least one data frame. The transmission power level may be the power level at which the random access trigger frame is sent to at least one of the one or more devices. The received signal power level may be a power level of a signal sent from the device and received at the access point. The one or more random access conditions may include a transmission power level associated with the access point, a maximum received signal power level associated with the access point, or a minimum received signal power level associated with the access point. The computer-executable instructions to select one of the one or more random access resource units may further include computer-executable instructions to select one of the one or more random access resource units when the receive signal power level is greater than or equal to the minimum receive signal power level and when the receive signal power level is less than or equal to the maximum receive signal power level. The at least one processor of the one or more processors may be further configured to execute the computer-executable instructions to determine a path loss power level based at least in part on the transmission power level associated with the access point and the measured power level of the random access trigger frame. The computer-executable instructions to determine a receive signal power level associated with the access point may further include computer-executable instructions to subtract the path loss power level from the transmit power level. The power level of the random access trigger frame may be a received signal strength indication (RSSI) measurement. Implementations of the described techniques may include hardware, a method or process, or computer software on a computer-accessible medium.

One general aspect includes a non-transitory computer-readable medium storing computer-executable instructions which, when executed by a processor, may cause the processor to perform operations including: determining a transmission power level; determining a maximum received signal power level and a minimum received signal power level associated with at least one signal received from one or more devices; generating a random access trigger frame including at least in part one or more random access resource units and one or more random access conditions, the one or more random access conditions may include at least one of the transmission power level, the maximum received signal power level, or the minimum received signal power level; causing to send the random access trigger frame to at least one of the one or more devices; and identifying at least one data frame received from at least one of the one or more devices. Other embodiments of this aspect include corresponding computer systems, apparatus, and computer programs recorded on one or more computer storage devices, each configured to perform the actions of the methods.

Implementations may include one or more of the following features. The non-transitory computer-readable medium where the at least one data frame is received on one of the one or more random access resource units. The one or more resource units may be orthogonal frequency division multiple access (OFDMA) resource units. The computer-executable instructions may cause the processor to further perform operations including causing to send a multi user block acknowledgment to at least one of the one or more devices based at least in part on the received at least one data frame. The transmission power level may be the power level at which the random access trigger frame is sent to at least one of the one or more devices. The received signal power level may be a power level of a signal sent from the device and received at the access point. The one or more random access conditions may include a transmission power level associated with the access point, a maximum received signal power level associated with the access point, or a minimum received signal power level associated with the access point. The computer-executable instructions to select one of the one or more random access resource units may further include computer-executable instructions to select one of the one or more random access resource units when the receive signal power level is greater than or equal to the minimum receive signal power level and when the receive signal power level is less than or equal to the maximum receive signal power level. The at least one processor of the one or more processors may be further configured to execute the computer-executable instructions to determine a path loss power level based at least in part on the transmission power level associated with the access point and the measured power level of the random access trigger frame. The computer-executable instructions to determine a receive signal power level associated with the access point may further include computer-executable instructions to subtract the path loss power level from the transmit power level. The power level of the random access trigger frame may be a received signal strength indication (RSSI) measurement. Implementations of the described techniques may include hardware, a method or process, or computer software on a computer-accessible medium.

One general aspect includes a wireless device, including: at least one memory that stores computer-executable instructions; and at least one processor of the one or more processors configured to access the at least one memory, where the at least one processor of the one or more processors may be configured to execute the computer-executable instructions to: identify a random access trigger frame on a communication channel, the trigger frame may include at least in part one or more random access resource units and one or more random access conditions; measure a power level of the random access trigger frame; determine a transmit power level associated with the device; determine a received signal power level associated with the access point based at least in part on the one or more random access conditions; select one of the one or more random access resource units based at least in part on satisfying the one or more random access conditions; and identify at least one multi-user block acknowledgement (MU-BA) frame received from the access point; Other embodiments of this aspect include corresponding computer systems, apparatus, and computer programs recorded on one or more computer storage devices, each configured to perform the actions of the methods.

Implementations may include one or more of the following features. The received signal power level is a power level of a signal sent from the device and received at the access point. The one or more random access conditions may include a transmission power level associated with the access point, a maximum received signal power level associated with the access point, or a minimum received signal power level associated with the access point. The computer-executable instructions to select one of the one or more random access resource units further may include computer-executable instructions to select one of the one or more random access resource units when the receive signal power level is greater than or equal to the minimum receive signal power level and when the receive signal power level is less than or equal to the maximum receive signal power level. The at least one processor of the one or more processors may be further configured to execute the computer-executable instructions to determine a path loss power level based at least in part on the transmission power level associated with the access point and the measured power level of the random access trigger frame. The computer-executable instructions to determine a receive signal power level associated with the access point may further include computer-executable instructions to subtract the path loss power level from the transmit power level. The power level of the random access trigger frame may be a received signal strength indication (RSSI) measurement. Implementations of the described techniques may include hardware, a method or process, or computer software on a computer-accessible medium.

According to example embodiments of the disclosure, there may be a wireless apparatus. The wireless apparatus may include means for identifying a random access trigger frame on a communication channel, received from an access point, the trigger frame may include at least in part one or more random access resource units and one or more random access conditions. The wireless apparatus may include means for measuring a power level of the random access trigger frame. The wireless apparatus may include means for determining a transmit power level associated with the device. The wireless apparatus may include means for determining a received signal power level associated with the access point based at least in part on the one or more random access conditions. The wireless apparatus may include means for selecting one of the one or more random access resource units based at least in part on satisfying the one or more random access conditions. The wireless apparatus may include means for identifying at least one multi-user block acknowledgement (MU-BA) frame received from the access point.

Implementations may include one or more of the following features. The received signal power level may be a power level of a signal sent from the device and received at the access point. The one or more random access conditions comprise a transmission power level associated with the access point, a maximum received signal power level associated with the access point, or a minimum received signal power level associated with the access point. The power level of the random access trigger frame is a received signal strength indication (RSSI) measurement. The computer-executable instructions to select one of the one or more random access resource units further include computer-executable instructions to select one of the one or more random access resource units when the receive signal power level may be greater than or equal to the minimum receive signal power level and when the receive signal power level may be less than or equal to the maximum receive signal power level. The at least one processor of the one or more processors may be further configured to execute the computer-executable instructions to determine a path loss power level based at least in part on the transmission power level associated with the access point and the measured power level of the random access trigger frame. The computer-executable instructions to determine a receive signal power level associated with the access point further may include computer-executable instructions to subtract the path loss power level from the transmit power level.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, comprising:
at least one memory that stores computer-executable instructions; and
at least one processor of one or more processors configured to access the at least one memory, wherein the at least one processor is configured to execute the computer-executable instructions to:
identify a trigger frame received on a communication channel from a first device, the trigger frame including identification of at least in part one or more random access resource units and one or more random access conditions;
determine the trigger frame is a random access trigger frame;
measure a power level of the random access trigger frame;
determine a transmit power level associated with the device; and
determine a received signal power level associated with the first device based at least in part on the one or more random access conditions.

2. The device of claim 1, wherein the at least one processor is further configured to execute the computer-executable instructions to:
waiting to transmit one or more uplink data frames when the received signal power does not satisfy at least one of the one or more random access conditions.

3. The device of claim 1, wherein the at least one processor is further configured to execute the computer-executable instructions to:
determine a second transmit power level associated with the device based at least in part on the received signal power level and the one or more conditions; and
cause to send one or more uplink data frames at the second transmit power level.

4. The device of claim 1, wherein the one or more random access conditions comprise a transmission power level associated with the first device, a maximum received signal power level associated with the first device, or a minimum received signal power level associated with the first device.

5. The device of claim 4, wherein the at least one processor is further configured to execute the computer-executable instructions to:
select one of the one or more random access resource units when the receive signal power level is greater than or equal to the minimum receive signal power level and when the receive signal power level is less than or equal to the maximum receive signal power level; and
cause to send one or more uplink data frames to the first device using the selected one of the one or more random access resource units.

6. The device of claim 4, wherein the at least one processor is further configured to execute the computer-executable instructions to determine a path loss power level based at least in part on the transmission power level associated with the first device and the measured power level of the random access trigger frame.

7. The device of claim 1, further comprising a transceiver configured to transmit and receive wireless signals.

8. The device of claim 7, further comprising an antenna coupled to the transceiver.

9. A non-transitory computer-readable medium storing computer-executable instructions which, when executed by a processor, cause the processor to perform operations comprising:
determining a transmission power level;
determining a maximum received signal power level and a minimum received signal power level associated with at least one signal received from one or more devices;
generating a random access trigger frame including at least in part an identification of one or more random access resource units and one or more random access conditions, the one or more random access conditions includes at least one of the transmission power level, the maximum received signal power level, or the minimum received signal power level;
causing to send the random access trigger frame to at least one of the one or more devices; and
identifying at least one data frame received from at least one of the one or more devices.

10. The non-transitory computer-readable medium of claim 9, wherein the at least one data frame is received on one of the one or more random access resource units.

11. The non-transitory computer-readable medium of claim 9, wherein the one or more resource units include Orthogonal Frequency Division Multiple Access (OFDMA) resource units.

12. The non-transitory computer-readable medium of claim 9, wherein the computer-executable instructions cause the processor to further perform operations comprising causing to send a multi user block acknowledgment to at least one of the one or more devices based at least in part on the received at least one data frame.

13. The non-transitory computer-readable medium of any one of claims 9-12, wherein the transmission power level is the power level at which the random access trigger frame is sent to at least one of the one or more devices.

14. A wireless device, comprising:
at least one memory that stores computer-executable instructions; and
at least one processor of the one or more processors configured to access the at least one memory, wherein the at least one processor of the one or more processors is configured to execute the computer-executable instructions to:
identify a random access trigger frame on a communication channel, the trigger frame includes at least in part one or more random access resource units and one or more random access conditions;
measure a power level of the random access trigger frame;
determine a transmit power level associated with the device;
determine a received signal power level associated with a access point based at least in part on the one or more random access conditions;
select one of the one or more random access resource units based at least in part on satisfying the one or more random access conditions; and
identify at least one multi-user block acknowledgement (MU-BA) frame received from the access point.

15. The wireless device of claim 14, wherein the computer-executable instructions to select one of the one or more random access resource units further include computer-executable instructions to:
determine a second transmit power level associated with the wireless device based at least in part on the received signal power level and the one or more conditions; and
cause to send one or more uplink data frames to the access point at the second transmit power level.

16. The wireless device of claim 14, wherein the one or more random access conditions comprise a transmission power level associated with the access point, a maximum received signal power level associated with the access point, or a minimum received signal power level associated with the access point.

17. The wireless device of claim 14, wherein the power level of the random access trigger frame is a received signal strength indication (RSSI) measurement.

18. The wireless device of claim 16, wherein the computer-executable instructions to select one of the one or more random access resource units further include computer-executable instructions to select one of the one or more random access resource units when the receive signal power level is greater than or equal to the minimum receive signal power level and when the receive signal power level is less than or equal to the maximum receive signal power level.

19. The wireless device of claim 16, wherein the at least one processor of the one or more processors is further configured to execute the computer-executable instructions to determine a path loss power level based at least in part on the transmission power level associated with the access point and the measured power level of the random access trigger frame.

20. The wireless device of claim 19, wherein the computer-executable instructions to determine a receive signal power level associated with the access point further includes computer-executable instructions to subtract the path loss power level from the transmit power level.
